(19) United States
(12) Patent Application Publication
(10) Pub. No.: US 2009/0054595 A1
(43) Pub. Date: Feb. 26, 2009

(54) Compounding Formulations for Producing Articles from Guayule Natural Rubber

(75) Inventors: Katrina Cornish, Casa Grande, AZ (US); Jali L. Williams, Phoenix, AZ (US); KC Nguyen, Maricopa, AZ (US)

Correspondence Address: HOLME ROBERTS & OWEN LLP, 16427 N. SCOTTSDALE RD., SUITE 300, SCOTTSDALE, AZ, 85254, US

(73) Assignee: Yulex Corporation

(21) Appl. No.: 11/842,939

(22) Filed: Aug. 21, 2007

(51) Int. Cl. C08J 3/26; C08L 7/02

(52) U.S. Cl. 525/326.1; 252/182.17; 264/39

(57) ABSTRACT

The invention disclosed herein relates to a process for making elastomeric rubber articles, and in particular, the process of producing such articles from non-Hevea brazilensis rubber sources, such as Guayule (Parthenium argentatum) natural rubber that exhibits physical strength properties similar to or superior to that of Hevea brazilensis natural rubber latex. In one embodiment, the process comprises an accelerator composition at the pre-cure stage comprised of variable combinations of a dithiocarbamate, a thiazole, a guanidine, a thiuram, or a sulfenamide. The accelerator composition may be comprised of, but is not limited to, zinc diethyldithiocarbamate (ZDEC), t-butyl benzothiazosulfenamide (TBBS) and diphenyl guanidine (DPG); an accelerator composition comprised of zinc diethyldithiocarbamate (ZDEC), n-cyclohexyl benzothiazosulfenamide (CBTS) and diphenyl guanidine (DPG). The disclosed invention also includes the elastomeric articles made by the disclosed process.

### FIELD OF THE INVENTION

The invention disclosed herein relates to a process for making elastomeric rubber articles, and in particular, the process of producing articles from non-Hevea brazilensis rubber sources, such as guayule (Parthenium argentatum) natural rubber that exhibits physical strength properties similar to or superior to that of Hevea brazilensis natural rubber latex.

### BACKGROUND OF THE INVENTION

Natural rubber, derived from the plant Hevea brasiliensis, is a core component of many industrial products such as in coatings, films, and packaging. Natural rubber is also used widely in medical devices and consumer items. More specifically, latex is used in medical products including: gloves, catheters, laboratory testing equipment, assays, disposable kits, drug containers, syringes, valves, seals, ports, plungers, forceps, droppers, stoppers, bandages, dressings, examination sheets, wrappings, coverings, tips, shields, and sheaths for endo-devices, solution bags, balloons, thermometers, spatulas, tubing, binding agents, transfusion and storage systems, needle covers, tourniquets, tapes, masks, stethoscopes, medical adhesive, and latex wound-care products.

Post-procedure patient uses for natural rubber include: compression bands, ties, and straps, inflation systems, braces, splints, cervical collars, and other support devices, belts, clothing, and the padding on wheelchairs and crutches. Natural latex is also used in many other common household products such as pacifiers, rubber bands, adhesives, condoms, disposable diapers, art supplies, toys, baby bottles, chewing gum, and electronic equipment, to name just a few.

However, the widespread use of natural rubber is problematic for several reasons. First, the vast majority of Hevea-derived natural rubber is grown from a limited number of cultivars in Indonesia, Malaysia and Thailand, using labor-intensive harvesting practices. The rubber and products made from Hevea are expensive to import to other parts of the world, including the United States, and supply chains can limit availability of materials. Furthermore, because of the restricted growing area and genetic similarity of these crops, plant blight, disease, or natural disaster has the potential to wipe out the bulk of the world's production in a short time. Second, particularly in the medical and patient care areas, an estimated 20 million Americans have allergies to proteins found in the Southeast Asian Hevea-derived natural rubber crop.

### BRIEF DESCRIPTION OF THE DRAWINGS

FIG. 1 illustrates the guayule latex film making process according to the present disclosure.

FIG. 2 is a graph depicting the tensile results of various combinations of antioxidant and accelerator at constant sulfur.

FIG. 3 is a graph depicting the tensile properties of guayule latex films cured at various levels of antioxidant, accelerator and sulfur.

FIG. 4 is a graph depicting the effect of raw latex storage time at ambient temperature on compounded film tensile strength using the GL9 formulation disclosed in Table 4.

FIG. 5 is a graph depicting the physical properties of films produced from compounded latex performance stored for different time periods before dipping.

FIG. 6 is a graph depicting the puncture test comparison of guayule latex films versus Hevea NRL and other synthetic elastomers using 23G hypodermic needle.

FIG. 7 is a graph depicting the tear test results of guayule latex films versus Hevea NRL and other synthetic elastomers.

FIG. 8 is a bar graph depicting various physical properties results of guayule latex films versus Hevea NRL and other synthetic elastomers.

FIG. 9 illustrates various examples of compounding formulations according to the present disclosure.

### DETAILED DESCRIPTION

The present disclosure is directed to a process for making elastomeric rubber articles, and in particular, the process of producing such articles from non-Hevea brazilensis rubber sources, such as guayule natural rubber, that exhibits physical strength properties similar to or superior to that of Hevea brazilensis natural rubber latex. In one embodiment, the process comprises an accelerator composition at the pre-cure stage comprised of variable combinations of a dithiocarbamate, a thiazole, a guanidine, a thiuram, or a sulfenamide. The accelerator composition may be comprised of, but is not limited to, zinc diethyldithiocarbamate (ZDEC), t-butyl benzothiazosulfenamide (TBBS) and diphenyl guanidine (DPG); an accelerator composition comprised of zinc diethyldithiocarbamate (ZDEC), n-cyclohexyl benzothiazosulfenamide (CBTS) and diphenyl guanidine (DPG).

Guayule, Parthenium argentatum, latex is commercially available as an alternate rubber source (Yulex® Latex) and is currently the sole natural rubber of U.S. domestic origin. It is the world's first natural rubber latex that is safe for Type 1 latex allergy sufferers due to its lack of proteins that cross-react with Hevea latex antigenic proteins, and is the only natural rubber latex to meet the current requirements of ASTM D1076 Category 4. Guayule a desert plant native to the southwestern United States and northern Mexico, produces polymeric isoprene essentially identical, or of improved latex quality, when compared with Hevea latex.

Examples of other non-Hevea natural rubber sources include, but are not limited to, gopher plant (Euphorbia lathyris), mariola (Parthenium incanum), rabbitbrush (Chrysothamnus nauseosus), milkweeds (Asclepias sp.), goldenrods (Solidago sp.), pale Indian plantain (Cacalia atripilcifolia), rubber vine (Crypstogeia grandiflora), Russian dandelion (Taraxacum sp. and Scorzonera sp.), mountain mint (Pycnanthemum incanum), American germander (Teucreum canadense) and tall bellflower (Campanula america). All of these non-Hevea natural rubber sources are capable of being evaluated according to the disclosed method to determine suitability for use in the disclosed non-synthetic, low-protein, low-allergenic latex products. Thus, the terms non-Hevea natural rubber latex and guayule latex are used interchangeably in the present disclosure.

There are currently 40,000 consumer and industrial products that utilize Hevea natural rubber latex (NRL) and other synthetic rubbers. As disclosed herein, guayule latex performance is superior to Hevea NRL and other synthetic elastomers and can effectively be used as a substitute. Thus, the present disclosure also provides for and specifically discloses non-Hevea, non-synthetic elastomeric articles made by the disclosed process. The products include, but are not limited to, gloves, condom, catheters, laboratory testing equipment, assays, disposable kits, drug containers, syringes, valves, seals, ports, plungers, forceps, droppers, stoppers, bandages, dressings, examination sheets, wrappings, coverings, tips, shields, and sheaths for endo-devices, solution bags, balloons, thermometers, spatulas, tubing, binding agents, transfusion and storage systems, needle covers, tourniquets, tapes, masks, stethoscopes, medical adhesive, and latex wound-care products.

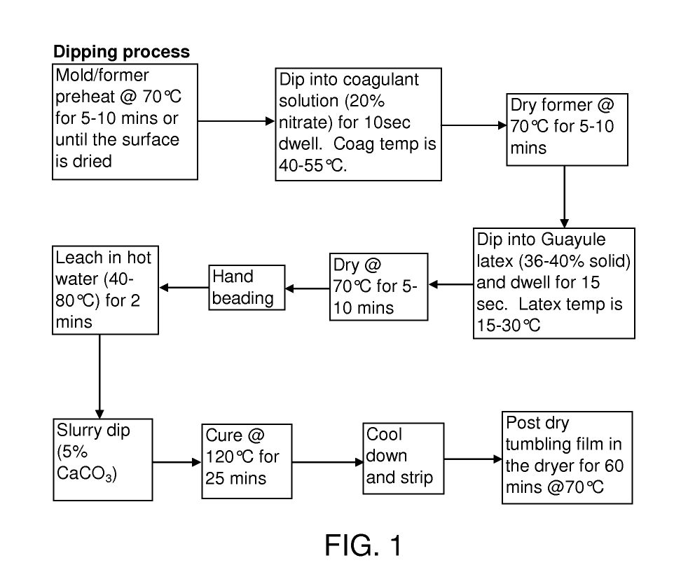

According to one embodiment of the present disclosure, the disclosed process begins with the preparation of the compounded guayule natural rubber latex (GNRL) composition, as described in further detail in FIG. 1. The GNRL is combined with one of the accelerator compositions and additional ingredients to prepare the GNRL composition in accordance with the invention. The function of the accelerator is to increase the rate of vulcanization, or the cross-linking density of GNRL to enhance the curing properties of the latex during the curing stages of the process. The accelerator composition of the present disclosure can be used in conjunction with conventional equipment and materials otherwise known to be used in the manufacture of elastomeric articles composed of NRL.

In one embodiment, the accelerator composition of the present disclosure comprises at least one dithiocarbamate, at least one thiazole, and at least one guanidine compound. In an alternate embodiment, the accelerator composition comprises at least one dithiocarbamate, at least one sulfenamide, and at least one guanidine compound. In a further embodiment, the accelerator composition comprises at least one dithiocarbamate, and at least one sulfenamide compound. In yet a further composition, the accelerator composition comprises at least one dithiocarbamate, and at least one guanidine compound. And, in yet another embodiment, the accelerator composition comprises at least one dithiocarbamate, and at least one thiuram compound.

Preferably, the dithiocarbamate compound for use with the invention is zinc diethyldithiocarbamate, also known as ZDEC or ZDC. Suitable ZDEC for use includes Bostex™ 561 (commercially available from Akron Dispersions, Akron, Ohio). The preferred thiazole compound for use in the invention is zinc 2-mercaptobenzothiazole, also known as zinc dimercaptobenzothiazole or ZMBT. Suitable ZMBT which can be used includes Bostex™ 482A (commercially available from Akron Dispersions, Akron, Ohio).

In another embodiment, the guanidine compound used in the accelerator composition is diphenyl guanidine, also known as DPG. Suitable DPG which can be used includes Bostex™ 417 (commercially available from Akron Dispersions, Akron, Ohio). In a preferred embodiment, a sulfenamide compound used in the accelerator composition is t-butylbenzothiazole sulfenamide, also known as TBBS. Suitable TBBS for use includes 50% BBTS (available from Akron Dispersions, Akron, Ohio).

A second sulfenamide used in the accelerator composition is n-cyclohexylbenzothiazole sulfenamide, also known as CBTS or CBS. Suitable CBS which can be used includes 50% CBS (available from Akron Dispersions, Akron, Ohio). Other dithiocarbamate, thiazole, sulfenamide, thiuram, and guanidine derivatives also can be used in accordance with the invention, provided each is chemically compatible with, i.e., does not substantially interfere with the functionality of, the remaining two accelerator compounds used.

Dithiocarbamate derivatives which also can be used include zinc dimethyldithiocarbamate (ZMD), sodium dimethyldithiocarbamate (SMD), bismuth dimethyldithiocarbamate (BMD), calcium dimethyldithiocarbamate (CAMD), copper dimethyldithiocarbamate (CMD), lead dimethyldithiocarbamate (LMD), selenium dimethyldithiocarbamate (SEMD), sodium diethyldithiocarbamate (SDC), ammonium diethyldithiocarbamate (ADC), copper diethyldithiocarbamate (CDC), lead diethyldithiocarbamate (LDC), selenium diethyldithiocarbamate (SEDC), tellurium diethyldithiocarbamate (TEDC), zinc dibutyldithiocarbamate (ZBUD), sodium dibutyldithiocarbamate (SBUD), dibutyl ammonium dibutyldithiocarbamate (DBUD), zinc dibenzyldithiocarbamate (ZBD), zinc methylphenyl dithiocarbamate (ZMPD), zinc ethylphenyl dithiocarbamate (ZEPD), zinc pentamethylene dithiocarbamate (ZPD), calcium pentamethylene dithiocarbamate (CDPD), lead pentamethylene dithiocarbamate (LPD), sodium pentamethylene dithiocarbamate (SPD), piperidine pentamethylene dithiocarbamate (PPD), and zinc lopetidene dithiocarbamate (ZLD).

Other thiazole derivatives which can be used include zinc 2-mercaptobenzothiazole (ZMBT), 2-mercaptobenzothiazole (MBT), copper dimercaptobenzothiazole (CMBT), benzothiazyl disulphide (MBTS), and 2-(2′,4′-dinitrophenylthio) benzothiazole (DMBT). Other sulfenamide derivatives include 2-morpholinothiobenzothiazole (MBS), n-dicyclohexylbenzothiazole-2-sulfenamide (DCBS), n-oxyethylenethiocarbamyl-n-oxydiethylene sulfenamide. Thiuram derivatives which can be used include tetraethylthiuram disulfide (TETD), tetramethylthiuram monosulfide (TMTM), tetramethylthiuram disulfide (TMTD), and tetrabenzylthiuram disulfide (TBzTD). Other guanidine derivatives which can be used include diphenyl guanidine acetate (DPGA), diphenyl guanidine oxalate (DPGO), diphenyl guanidine phthalate (DPGP), di-o-tolyl guanidine (DOTG), phenyl-o-tolyl guanidine (POTG), and triphenyl guanidine (TPG).

Prior to the dipping and curing steps, the compounded latex including the accelerator composition can be used immediately or stored for a period of time prior to its employment in the dipping process. When the compounded GNRL composition is ready for use or following storage, a former/mold in the overall shape of the article to be manufactured is first dipped into a coagulant composition to form a coagulant layer directly on the former. Next, the coagulant-coated former is dried and then dipped into the compounded GNRL composition.

The latex-covered former is then subjected to the curing step. The latex is cured directly on the former at elevated temperatures thereby producing an article in the shape of the former. The latex compound may be prevulcanized, which is after mixing the desired formulation it is then subjected to controlled heating for a period of time prior to use (prevulc). Alternatively, the latex compound may be postvulcanized whereby the latex compound is stored in desired conditions for an extended period of time before use.

In the case of prevulcanized latex, the preferred compound formulation is mixed and heated to 36-42° C. and held for 14-16 hours. Typically, stirring of the latex is applied during this prevulcanization. After the required time has elapsed, the compound is chilled to 15-25° C., then filtered, and is then ready for use. The compound is able to be confirmed ready for use by utilizing the modified toluene swell test disclosed herein in Example 2 to ensure that the required state of cure has been achieved. Alternatively, the compound may be mixed as described above and stored until the required time of use. The modified toluene swell test also should be applied to confirm that the latex has reached the required state of cure.

Further steps are typically performed as well, such as leaching with water, beading the cuff, and the like. These techniques are well-known in the art. Additional post-treatment processes and techniques steps are often performed as well, such as lubrication and coating, halogenation (e.g., chlorination), and sterilization. A variety of elastomeric articles can be made in accordance with the invention. Such elastomeric articles include, but are not limited to, medical gloves, condoms, probe covers (e.g., for ultrasonic or transducer probes), dental dams, finger cots, catheters, and the like as described above. As the present disclosure provides numerous advantages and benefits in a number of ways, any form of elastomeric article which can be composed of GNRL can benefit from the use of the disclosed process.

### EXAMPLE 1

### Effect of Antioxidant and Accelerator

Initially, the effect of the accelerator (Vanax PIC) and antioxidant (Vanox SPL) on guayule latex was investigated. Vanax PIC and Vanox SPL were obtained from R. T. Vanderbilt. Table 1 lists the guayule latex compounding components at various levels of antioxidant and accelerator while keeping the sulfur level constant at 2.5 phr (parts per hundred rubber).

TABLE 1

| Compound | GL1 | GL2 | GL3 | GL4 | GL5 | Add in |
|---|---|---|---|---|---|---|
| Ingredient | dry-phr | dry-phr | dry-phr | dry-phr | dry-phr | order |
| Guayule latex | 100 | 100 | 100 | 100 | 100 | 1 |
| Ammonia | 0.5 | 0.5 | 0.5 | 0.5 | 0.5 | 2 |
| Accelerator | 2 | 1 | 1.5 | 1 | 2 | 3 |
| (ACC) | | | | | | |
| Antioxidant | 1 | 2 | 1.5 | 1 | 2 | 4 |
| (AO) | | | | | | |
| TiO₂ - Optional | 0.5 | 0.5 | 0.5 | 0.5 | 0.5 | 5 |
| Sulfur | 2.5 | 2.5 | 2.5 | 2.5 | 2.5 | 6 |

In this example, the guayule latex was compounded and heated in an oven or water bath at 36° C. (96.8° F.) for 15 h. Following prevulcanization, the guayule latex compounds were cooled to 25° C.±2° C. and a modified toluene swell index test was performed as outlined below in Example 2.

### EXAMPLE 2

### Modified Toluene Swell Test

Two different examples of how modified toluene swell test method is performed are disclosed here in Example 2. In the first example, Pour 1.5 ml of 5% CaCO₃ solution (CaCO₃ and H₂O) into either aluminum or polypropylene weighing dish and dry it in 65° C. oven or air dry until it dried. Cool it down then put 1.5 ml of compounded latex into it, spread evenly over the tray, and air dry until it completely dried. Coat the top surface of the film with CaCO₃ powder to avoid blocking. Use 25 m circle die and cut a 25 mm film. Put it into a Petri dish filled with 20-30 ml of toluene and let it sit for 15 minutes. Hand stir the Petri dish every 3-5 minutes if needed to avoid the bottom of film sticking to the Petri dish surface. After 15 minutes, measure the final diameter of the film. Perform the swell % calculation which is calculated by the following Equation 1 with the initial diameter equaling 25 mm. According to this first example, the swell percentage index lies between 84 and 172%.

Swell %=(final diameter−initial diameter)/initial diameter×100 EQUATION 1

In the second example, pour 0.75 ml of 5% aqueous CaCO₃ solution into either an aluminum or a polypropylene weighing dish and dry it either in a 65° C. oven or air dry at ambient temperature. Cool to room temperature, if oven dried, and add 1.5 ml of compounded latex. Gently swirl latex to form a uniform layer and air dry. Complete dryness is indicated when the film turns from opaque white to translucent amber.

Coat the top surface of the film with CaCO₃ powder to prevent the surface of the film from sticking to itself. Peel the film out of the weighing dish. Use a 25 mm circle die to cut a 25 mm film. Put it into a covered Petri dish containing toluene (10 mm height from the base of the Petri dish) for 15 mins. Hand swirl the Petri dish every 3-5 mins. to prevent the film from sticking to the Petri dish bottom. After 15 mins. measure the final diameter of the film through the base of the dish.

Good precure of the mature guayule latex compound is indicated by a swell index of between 110% and 172% of the original film diameter (25 mm). This contrasts with Hevea latex for which the swell index for good procure lies between 80 and 136%. This difference is most likely due to the greater linearity of the guayule polymer (lower branching and no gel) which permits greater swell due to fewer rubber polymer chain entanglements.

Guayule latex films were produced using the process described in FIG. 1. The unaged articles were conditioned in a desiccator for 24 h prior to physical property testing. The aged articles were aged in the oven at 70° C. for 7 days as specified by ASTM D 573. Testing of both unaged and accelerated aged physical properties were performed in accordance with ASTM D 412.

Due to the limitations of our tensiometer (Instron 3343 model, vertical test space 1067 mm) and the naturally high elongation of the guayule latex, ASTM D412 die “D” was selected to cut the dumbbells for the physical properties testing. ASTM D412 die “C” dumbbells may be used but require a 3345 model with a vertical test space greater than 1123 mm.

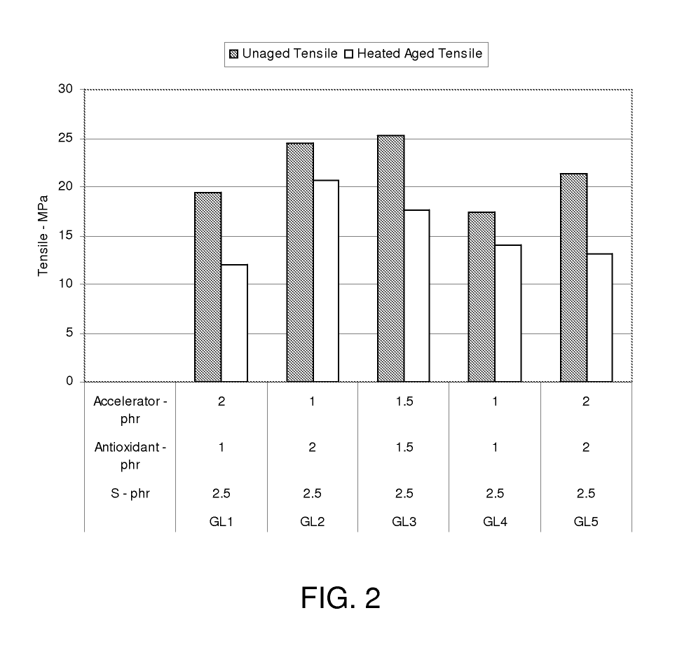

As outlined in FIG. 2 and Table 2, formula GL2 yielded both unaged and heated aged films with excellent physical properties, which met or exceeded the ASTM 3577 requirement for NRL surgical gloves. This DOE shows that in order to maintain high unaged and heated aged physical properties, the concentration of the accelerator must be on the low side and the level of the antioxidant must be on the high side.

TABLE 2

| | | | | Unaged Article | | | Aged Article | | |
|---|---|---|---|---|---|---|---|---|---|
| | | | | | Modulus | | | Modulus | |
| | S - | AO - | ACC - | | @ 500% - | Tensile - | | @ 500% - | Tensile - |
| Run # | phr | phr | phr | Elongation - % | MPa | MPa | Elongation - % | MPa | MPa |
| GL1 | 3 | 1 | 2 | 795 | 2.2 | 19.5 | 761 | 2.3 | 12.0 |
| GL2 | 3 | 2 | 1 | 953 | 1.6 | 24.5 | 948 | 1.7 | 20.7 |
| GL3 | 3 | 1.5 | 1.5 | 1011 | 1.8 | 25.3 | 710 | 3.3 | 17.6 |
| GL4 | 3 | 1 | 1 | 866 | 1.9 | 17.4 | 925 | 1.4 | 14.1 |
| GL5 | 3 | 2 | 2 | 919 | 1.7 | 21.3 | 633 | 2.5 | 13.1 |

### EXAMPLE 3

### Effect of Sulfur

After analyzing the results generated from the formulations in Table 1, additional DOE's (Table 3) were carried out to further optimize the physical properties of the guayule latex films. The effect of varying sulfur levels was tested at the constant accelerator and antioxidant concentrations of 1 and 2 phr, respectively.

TABLE 3

| | | | | | | Add |
|---|---|---|---|---|---|---|
| Compound | GL6 | GL7 | GL8 | GL9 | GL10 | in |
| Ingredient | dry-phr | dry-phr | dry-phr | dry-phr | dry-phr | order |
| Guayule latex | 100 | 100 | 100 | 100 | 100 | 1 |
| Ammonia | 0.5 | 0.5 | 0.5 | 0.5 | 0.5 | 2 |
| Accelerator | 1 | 1 | 1 | 1 | 1 | 3 |
| (ACC) | | | | | | |
| Antioxidant (AO) | 2 | 2 | 2 | 2 | 2 | 4 |
| TiO₂ - Optional | 0.5 | 0.5 | 0.5 | 0.5 | 0.5 | 5 |
| Sulfur | 2 | 2.3 | 2.5 | 3 | 3.5 | 6 |

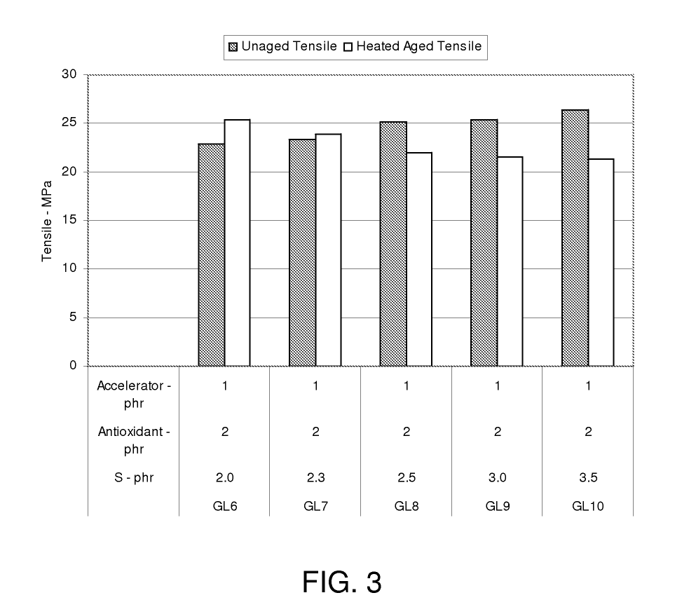

Table 4 and FIG. 3 indicate that unaged tensile properties improve with increasing sulfur concentration. However, the heat-aged tensile properties decline with increasing sulfur concentration. A sulfur concentration of 2.5-3.0 phr maximizes both the unaged and heat-aged physical properties.

TABLE 4

| | | | | Unaged Article | | | Aged Article | | |
|---|---|---|---|---|---|---|---|---|---|
| | | | | | Modulus | | | Modulus | |
| | S - | AO - | ACC - | | @ 500% - | Tensile - | | @ 500% - | Tensile - |
| Run # | phr | phr | phr | Elongation - % | MPa | MPa | Elongation - % | MPa | MPa |
| GL6 | 2.0 | 2 | 1 | 923 | 2.0 | 22.9 | 962 | 1.9 | 25.4 |
| GL7 | 2.3 | 2 | 1 | 947 | 1.9 | 23.3 | 924 | 1.9 | 24.0 |
| GL8 | 2.5 | 2 | 1 | 961 | 1.8 | 25.2 | 898 | 1.8 | 22.0 |
| GL9 | 3.0 | 2 | 1 | 1019 | 1.5 | 25.3 | 803 | 2.5 | 21.5 |
| Gl10 | 3.5 | 2 | 1 | 963 | 1.7 | 26.4 | 876 | 2.2 | 21.3 |

### EXAMPLE 4

### Master Batch Development and Testing

The effect of a master batch (MB) dispersion on guayule latex also was investigated. The Yulex® MB (Yulex Corp. and Akron Dispersions). As shown in Table 5, there was no significant difference between the MB compound method, in which the ingredients were pre-mixed before compounding, and the semi-continuous method, where individual components were added separately and mixed between each addition. Thus, the MB method provides an alternate way to compound guayule latex while simplifying and shortening the compounding process. The MB method also may reduce the total amount of compounding materials used.

TABLE 5

| | | | | Unaged Article | | | Aged Article | | |
|---|---|---|---|---|---|---|---|---|---|
| | | | | | Modulus | | | Modulus | |
| | S - | AO - | ACC - | | @ 500% - | Tensile - | | @ 500% - | Tensile - |
| Run # | phr | phr | phr | Elongation - % | MPa | MPa | Elongation - % | MPa | MPa |
| GL11 | 3.0 | 2 | 1 | 1027 | 1.5 | 24.1 | 789 | 2.6 | 23.3 |

| | | | | | | | |
|---|---|---|---|---|---|---|---|
| GL12 | Yulex ® master | 1022 | 1.6 | 25.1 | 836 | 2.3 | 22.8 |
| | batch | | | | | | |

### EXAMPLE 5

### Effect of Zinc Oxide

The effect of the ZnO also was examined to further maximize the performance of the guayule latex films. There was no significant impact on physical properties when ZnO was incorporated into the guayule latex formulation at 3 phr sulfur (Table 6). However, additional studies demonstrated that the ZnO (0.5-2.0 phr) yielded higher physical properties in the guayule latex when low amount of sulfur (1.0-2.5 phr) was used in the compounding. On the contrary, the use of ZnO (0.5-2.0 phr) yielded inferior physical properties, particularly of aged physical properties, when a high concentration of sulfur (2.5-3.5 phr) was used.

TABLE 6

| | | Unaged Article | | | Aged Article | | |
|---|---|---|---|---|---|---|---|
| | | | Modulus | | | Modulus | |
| | ZnO - | | @ 500% - | Tensile - | | @ 500% - | Tensile - |
| Run # | phr | Elongation - % | MPa | MPa | Elongation - % | MPa | MPa |
| GL12 | 0 | 1022 | 1.6 | 25.1 | 836 | 2.3 | 22.8 |
| GL13 | 0.5 | 1021 | 1.5 | 23.6 | 824 | 2.5 | 23.5 |
| GL14 | 1 | 1014 | 1.6 | 24.4 | 830 | 2.6 | 23.1 |

### EXAMPLE 6

### Raw Latex Maturation Versus Compounded Latex Physical Properties

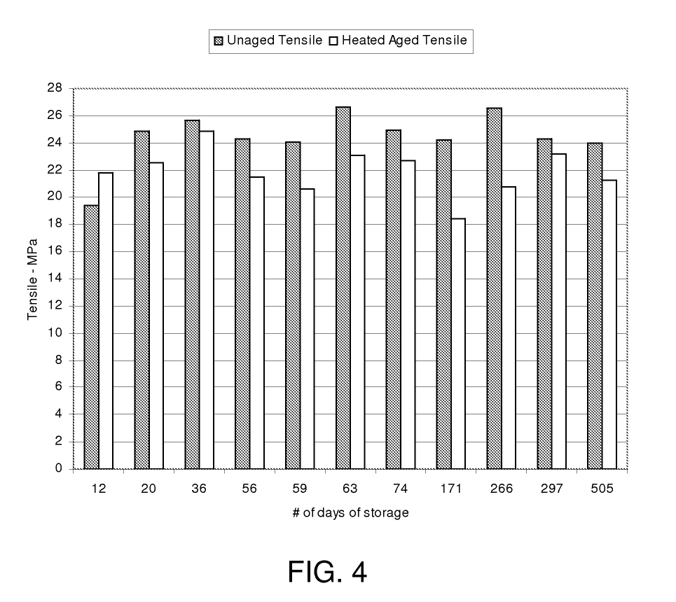

Different raw latex batches at various stages of maturation were used for the study. After the desired storage time, all batches were compounded using Formulation GL9 from Table 4. Guayule latex can be dipped as early as 20 days post-manufacture as compared to the typical 30 day minimum for Hevea latex (FIG. 4 and Table 7). Furthermore, the physical property results for the different latex batches after different storage periods beyond 20 days of age showed no statistically significant differences. Current data demonstrates that raw guayule latex is stable under good storage conditions for at least 16 months.

TABLE 7

| | | Unaged Article | | | Heated Aged Article | | |
|---|---|---|---|---|---|---|---|
| | Raw | | Modulus | | | Modulus | |
| # of day | latex | | @ 500% - | Tensile - | | @ 500% - | Tensile - |
| maturity | batch # | Elongation - % | MPa | MPa | Elongation - % | MPa | MPa |
| 12 | 061221 | 991 | 1.5 | 19.4 | 892 | 2.2 | 21.8 |
| 20 | 061221 | 976 | 2.0 | 24.9 | 813 | 2.5 | 22.5 |
| 36 | 061221 | 1022 | 1.8 | 25.7 | 915 | 2.3 | 24.9 |
| 56 | 060918 | 928 | 2.1 | 24.3 | 880 | 2.2 | 21.4 |
| 59 | 060918 | 978 | 2.0 | 24.1 | 820 | 2.5 | 20.6 |
| 63 | 060626 | 969 | 1.9 | 26.6 | 768 | 2.8 | 23.1 |
| 74 | 060824 | 1025 | 1.5 | 24.9 | 740 | 3.2 | 22.7 |
| 171 | 060626 | 1019 | 1.5 | 24.2 | 847 | 1.9 | 18.4 |
| 266 | Composite* | 1061 | 1.5 | 26.5 | 848 | 1.9 | 20.8 |
| | (266-343) | | | | | | |
| 297 | Composite* | 1032 | 1.5 | 24.3 | 857 | 2.5 | 23.1 |
| | (297-374) | | | | | | |
| 505 | 051715 | 1008 | 1.6 | 24.0 | 758 | 3.0 | 21.2 |

*Composite latex - Mixture of Latex produced form Jan. 09, 2006 to Mar. 27, 2006

### EXAMPLE 7

### Compounded Latex Pot-Life Determination

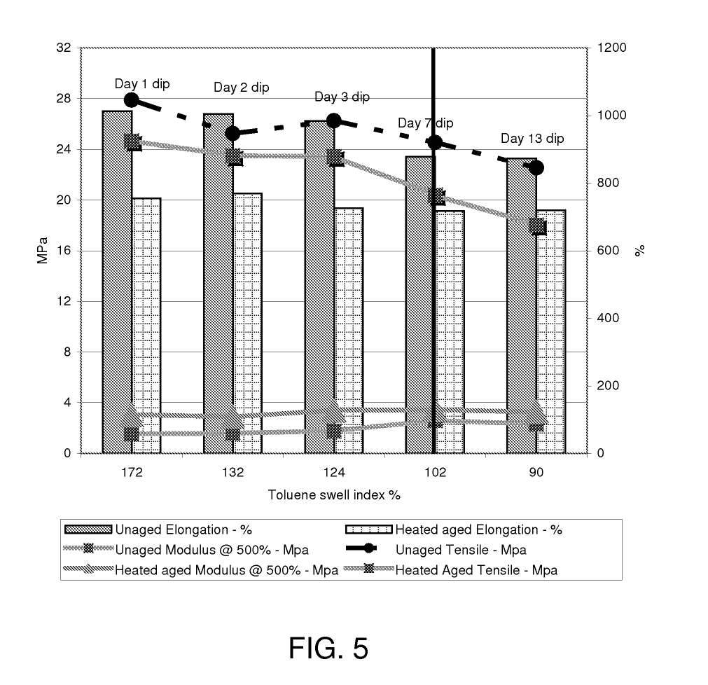

Based on the results established above, Formulation GL9 from Table 4 (3 phr of sulfur, 1 phr of accelerator and 2 phr of antioxidant) was selected to perform a pot life study of compounded latex. Compounded guayule latex was used to produce glove films over a 13-day period. Glove films were collected after 1, 2, 3, 7 and 13 days. The compounded latex was kept at ambient temperature (25-30° C.) with continuous mixing during dipping. However, there was no agitation or mixing at night. As seen in FIG. 5, the tensile and elongation trended down over time, while modulus trended up over time. The stability was excellent during the first 7 days, which indicates the pot life of this particular compounded latex batch is approximately between 7-13 days. In fact, both unaged and heated aged physical properties met the surgical latex ASTM D3577 standard comfortably. The swell index established for this study ranged from 102-172%.

### EXAMPLE 8

### Performance of Guayule Latex Files in Comparison with Hevea NRL and Several Synthetic Elastomers

A comparative study of guayule latex, Hevea NRL and other synthetic elastomers was performed to substantiate the product performance of guayule latex among commercially available Hevea NRL and other synthetic elastomers. Guayule latex films were produced in-house using formulation GL9 from Table 4 while commercially available Hevea NRL and other synthetic elastomers were obtained from several glove distributor sources. Physical property, tear and puncture resistance tests were performed and compared among films of guayule latex, Hevea NRL, deproteinized NRL, chloroprene, synthetic poly-isoprene, vinyl and nitrile.

Tear resistance testing was performed in accordance with ASTM D624. The die C tear test was used. Puncture resistance testing was performed in accordance with ASTM F1342. A 23 gauge hypodermic needle was used because probe A did not puncture the rubber films and failed to yield usable data.

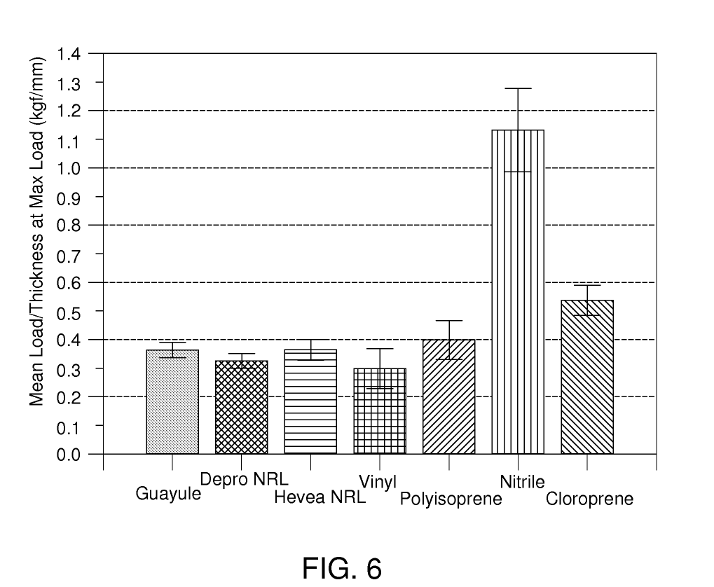

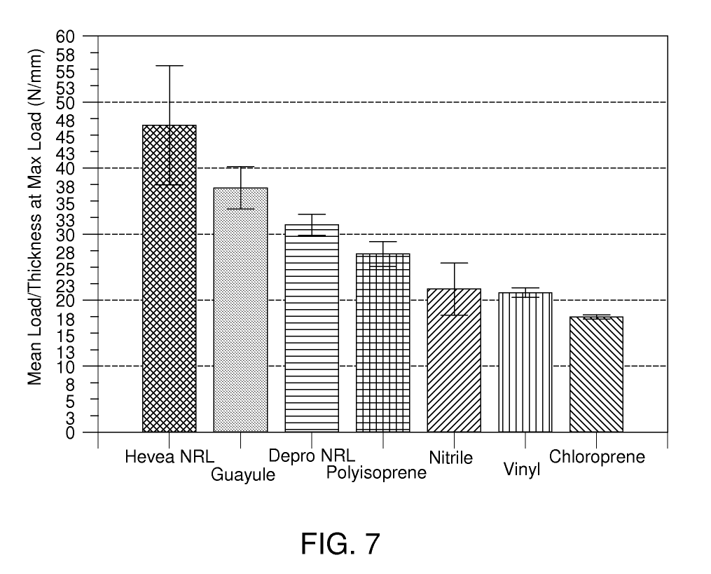

Guayule latex film puncture resistance was on par with the Hevea NRL and synthetic poly-isoprene films (FIG. 6). Although nitrile latex displayed the most puncture resistance of all, it did not display a high level of tear resistance (FIG. 7) and was the third lowest of all samples tested. Guayule latex tear resistance outperformed the synthetic materials, and was not significantly different to Hevea NRL.

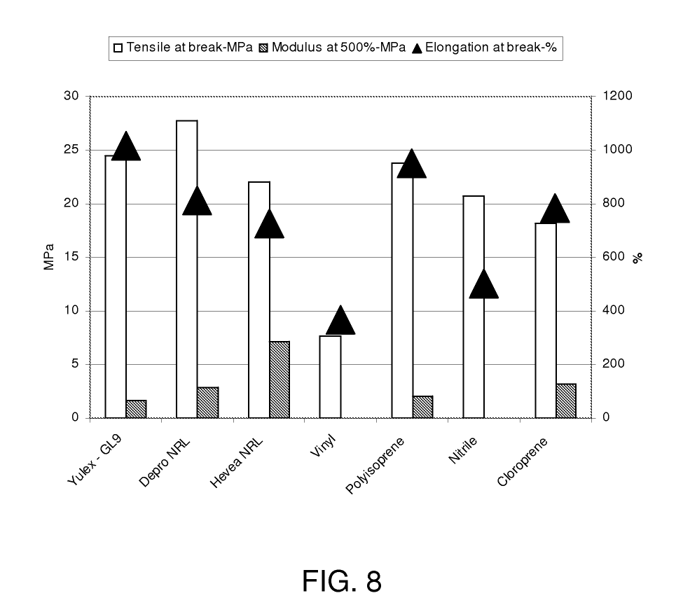

Physical property testing was performed according to ASTM D 412. ASTM D412 die D was used to cut the dumbbells for physical property testing. Guayule latex film tensile strength (24.5 MPa) was on par with Hevea NRL, deproteinized NRL and synthetic poly-isoprene, and out-performed the others (FIG. 8). Guayule latex film elongation averaged 1015% which is much higher than all other materials tested. Furthermore, guayule latex film modulus at 500% was 1.6 MPa, much lower than the other materials tested. These results indicate that the guayule latex is not only strong, but is a very supple and soft material that enhances comfort during product wear.

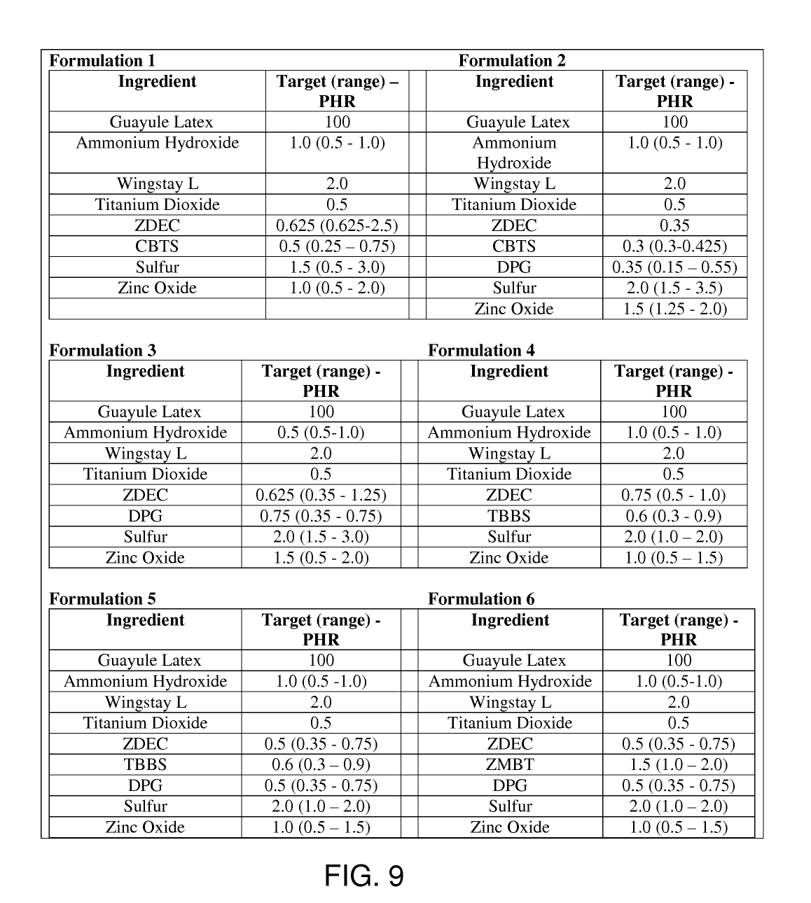

FIG. 9 illustrates other examples of formulations according to the present disclosure. The formulations disclosed herein allow for simplified formulating of Guayule natural rubber latex (GNRL) leading to films of sufficient integrity to allow production of articles easily able to meet product specific specifications, where previously formulations used were insufficient to achieve similar states of performance. Given the premium nature of the Guayule rubber latex, a great limitation to its widespread use would be to remain single-sourced for the critical compounding ingredients as one would be with a proprietary cure package. These formulations are based on primary ingredients which can be easily sourced internationally, and in fact share some ingredients in common with those used in Hevea NRL (NRL).

As a result of a combination of the polymer architecture and the compound formulation, films produced from GNRL reliably tend to be at least 50% lower in Modulus versus comparably compounded NRL. Modulus is a measure of the force required to stretch a sample to a given % elongation and correlates to softness—the lower the modulus the softer the film. Because GNRL falls into the niche between NRL in terms of physical performance & user comfort and synthetic polyisoprene's poorer performance but lack of type I antigenic cross-reactivite proteins, GNRL compounded using the described formulations allows a combination of the most favorable aspects of both rubber types.

Another advantage of the disclosed method is that conventional manufacturing equipment and most readily-available materials can be used in accordance with the invention to make a surgical glove, for example, without the need for new or costly additional materials or equipment. Further, no complicated new process steps are required by the invention and the invention can be readily incorporated into existing glove making processes and systems.

The compounded (or ready to use) GNRL composition formulated in accordance with the invention exhibits prolonged storage stability. For example, the pre-cure storage stability of the compounded GNRL composition (i.e., the time period prior to the use of the compounded polyisoprene latex composition in the dipping and curing stages) can extend up to about 7 days, in contrast to the typical current 3 to 5 day time period. By extending storage life of the latex, the amount of wasted latex can be significantly reduced and greater flexibility in scheduling manufacturing processes is permitted.

Unlike classic accelerators, the accelerators used in the inventions are either low or non-nitrosamine generating. Nitrosamines are potential carcinogens. The present disclosure thus provides for a low or non-carcinogenic latex product.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive nor limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention.

What is claimed is:

1. A method for making an elastomeric article, comprising:
preparing a non-Hevea natural rubber latex composition;
combining the non-Hevea natural rubber latex composition with an accelerator composition forming a compounded non-Hevea natural rubber latex composition, wherein the accelerator composition enhances the curing properties of the latex;
dipping a mold in the general shape of the article in a coagulent composition forming a coagulent layer on the mold;
drying the coagulent-coated mold;
dipping the coagulent-coated mold into the compounded non-Hevea natural rubber latex composition; and
curing the compounded non-Hevea natural rubber latex dipped mold thereby producing the elastomeric article.

2. The method of claim 1, wherein the non-Hevea natural rubber composition comprises guayule natural rubber latex.

3. The method of claim 1, wherein the accelerator composition comprises a dithiocarbamate compound, a thiazole compound and a guanidine compound.

4. The method of claim 1, wherein the accelerator composition comprises a dithiocarbamate compound, a sulfenamide compound and a guanidine compound.

5. The method of claim 1, wherein the accelerator composition comprises a dithiocarbamate compound and a sulfenamide compound.

6. The method of claim 1, wherein the accelerator composition comprises a dithiocarbamate compound and a guanidine compound.

7. The method of claim 1, wherein the accelerator composition comprises a dithiocarbamate compound and a thiuram compound.

8. The method of claim 1, wherein the accelerator composition includes a dithiocarbamate compound selected from the group consisting of zinc diethyldithiocarbamate, zinc dimethyldithiocarbamate, sodium dimethyldithiocarbamate, bismuth dimethyldithiocarbamate, calcium dimethyldithiocarbamate, copper dimethyldithiocarbamate, lead dimethyldithiocarbamate, selenium dimethyldithiocarbamate, sodium diethyldithiocarbamate, ammonium diethyldithiocarbamate, copper diethyldithiocarbamate, lead diethyldithiocarbamate, selenium diethyldithiocarbamate, tellurium diethyldithiocarbamate, zinc dibutyldithiocarbamate, sodium dibutyldithiocarbamate, dibutyl ammonium dibutyldithiocarbamate, zinc dibenzyldithiocarbamate, zinc methylphenyl dithiocarbamate, zinc ethylphenyl dithiocarbamate, zinc pentamethylene dithiocarbamate, calcium pentamethylene dithiocarbamate, lead pentamethylene dithiocarbamate, sodium pentamethylene dithiocarbamate, piperidine pentamethylene dithiocarbamate, and zinc lopetidene dithiocarbamate.

9. The method of claim 1, wherein the accelerator composition includes a thiazole compound selected from the group consisting of zinc 2-mercaptobenzothiazole, zinc dimercaptobenzothiazole, zinc 2-mercaptobenzothiazole, 2-mercaptobenzothiazole, copper dimercaptobenzothiazole, benzothiazyl disulphide, and 2-(2′,4′-dinitrophenylthio) benzothiazole.

10. The method of claim 1, wherein the accelerator composition includes a sulfenamide compound selected from the group consisting of t-butylbenzothiazole sulfenamide, n-cyclohexylbenzothiazole sulfenamide, 2-morpholinothiobenzothiazole, n-dicyclohexylbenzothiazole-2-sulfenamide, n-oxyethylenethiocarbamyl-n-oxydiethylene sulfenamide.

11. The method of claim 1, wherein the accelerator composition includes a guanidine compound selected from the group consisting of diphenyl guanidine, diphenyl guanidine acetate, diphenyl guanidine oxalate, diphenyl guanidine phthalate, di-o-tolyl guanidine, phenyl-o-tolyl guanidine, and triphenyl guanidine.

12. The method of claim 1, wherein the accelerator composition includes a tharium compound selected from the group consisting of tetraethylthiuram disulfide, tetramethylthiuram monosulfide, tetramethylthiuram disulfide, and tetrabenzylthiuram disulfide.

13. The method of claim 1, wherein the elastomeric article is selected from the group consisting of a glove, a condom, a catheter, laboratory testing equipment, an assay, a disposable kit, a drug container, a syringe, a valve, a seal, a port, a plunger, forceps, a dropper, a stopper, a bandage, a dressing, an examination sheet, a wrapping, a covering, a tip, a shield, a sheaths for endo-devices, a solution bag, a balloons, a thermometer, a spatula, tubing, a binding agent, a transfusion and storage system, a needle cover, a tourniquet, tape, a mask, a stethoscope, a medical adhesive, and a latex wound-care product.

14. The method of claim 1, wherein the compounded non-Hevea natural rubber latex composition is prevulcanized.

15. The method of claim 1, wherein the compounded non-Hevea natural rubber latex composition is postvulcanized.

16. The method of claim 1, wherein enhancing the curing properties of the latex includes increasing the rate of vulcanization.

17. The method of claim 1, wherein enhancing the curing properties of the latex includes increasing the cross-linking density of the non-Hevea natural rubber latex composition.

18. An elastomeric article made by the process of:
preparing a non-Hevea natural rubber latex composition;
combining the non-Hevea natural rubber latex composition with an accelerator composition forming a compounded non-Hevea natural rubber latex composition, wherein the accelerator composition enhances the curing properties of the latex;
dipping a mold in the general shape of the article in a coagulent composition forming a coagulent layer on the mold;
drying the coagulent-coated mold;
dipping the coagulent-coated mold into the compounded non-Hevea natural rubber latex composition; and
curing the compounded non-Hevea natural rubber latex dipped mold thereby producing the elastomeric article.

19. The elastomeric article of claim 1, wherein the elastomeric article is selected from a group consisting of: a glove, a condom, a catheter, laboratory testing equipment, an assay, a disposable kit, a drug container, a syringe, a valve, a seal, a port, a plunger, forceps, a dropper, a stopper, a bandage, a dressing, an examination sheet, a wrapping, a covering, a tip, a shield, a sheaths for endo-devices, a solution bag, a balloons, a thermometer, a spatula, tubing, a binding agent, a transfusion and storage system, a needle cover, a tourniquet, tape, a mask, a stethoscope, a medical adhesive, and a latex wound-care product.

20. An accelerator composition comprising a dithiocarbamate compound, a thiazole compound and a guanidine compound, wherein the composition is capable of enhancing the curing properties of a non-Hevea natural rubber latex composition.
